(19) United States
(12) Patent Application Publication
(10) Pub. No.: US 2023/0026191 A1
(43) Pub. Date: Jan. 26, 2023

(54) CONNECTION ELEMENT AND TOOL FOR SECURING A CONNECTION ELEMENT TO A COMPONENT VIA FRICTION WELDING

(71) Applicant: EJOT SE & Co. KG, Bad Berleburg (DE)

(72) Inventors: Dieter Kittel, Bad Laasphe (DE); Niko Müller, Bad Berleburg-Raumland (DE); Danni Engel, Henstedt-Ulzburg (DE)

(73) Assignee: EJOT SE & Co. KG, Bad Berleburg (DE)

(21) Appl. No.: 17/785,516

(22) PCT Filed: Dec. 3, 2020
(86) PCT No.: PCT/EP2020/084435

§ 371 Date: Jun. 15, 2022

(30) Foreign Application Priority Data
Dec. 19, 2019 (DE) 10 2019 135 240.1

(51) Int. Cl. B23K 35/02; B23K 20/12; B23K 20/22; F16B 11/00

(52) U.S. Cl. CPC B23K 35/0288; B23K 20/1295; B23K 20/22; F16B 11/004

(57) ABSTRACT

A connection element for securing to a component, in particular a component made of a fiber composite material, comprising a main part, a functional part and a friction welding inlay, which in turn comprises a thermoplastic material. A tool application point is formed on an upper side of the main part. The friction welding inlay may be interlocking.

The invention relates to a connection element, in particular a thermal adhesive bonding boss, for securing to the surface of a component made of a fiber-reinforced composite material, such as CFRP or GFRP.

Such connection elements are required, for example, in order to secure attachments to weight-optimized CFRP components or to connect them to other parts. In the case of components made of fiber composite materials, it is in many cases undesirable or even impossible to drill through the component in order to guide a rivet or screw through the component and to connect the connection element to the component in this known and well-established manner. This restriction is due to the fact that each bore disrupts the fiber pattern within the component made of a fiber-reinforced composite material (composite material component) and reduces its load-bearing capacity. In addition, improper introduction of a bore can lead to delamination.

To avoid these disadvantages, such connection elements have been glued to the surface of the CFRP component in the past. However, this securing technique has various disadvantages. In particular the long curing time of the adhesive for automated serial production and the difficulties in producing such an adhesive bond in a process-reliable manner are disadvantageous.

The problem addressed by the invention is that of providing a connection element which avoids the disadvantages of the prior art. Said connection element is intended to be able to be connected to the component in a process-reliable and automated manner without the component requiring a bore. In addition, it is not only intended to be cost-effective, but also flexibly adaptable to different tasks/securing tasks.

This problem is solved according to the invention by a connection element, in particular a thermal adhesive bonding boss, for securing to the surface of a component by friction welding, comprising a main part and a functional part, the main part having an upper side and an underside which is opposite the upper side and has an annular bead, the main part having an opening connecting the upper side and the underside, and the functional part having a shank and a head at a first end of the shank, the diameter or extension of which head transverse to a longitudinal axis of the shank is greater than a diameter of the opening in the main part.

The connection element according to the invention is therefore in two parts. The connection element comprises a base part which has a bead on the underside thereof. The bead “supplies” the welding addition during friction welding. In addition, the friction welding process and the strength of the friction welded connection can be simply and flexibly adapted to the composite material component and the securing task by a corresponding design (in particular diameter, width, height and cross-sectional shape).

Furthermore, the connection element according to the invention comprises a functional part, the shank of which is inserted from below through the opening in the main part until the head of the functional part abuts the underside of the main part. Tensile forces can then be transmitted between the functional part and the main part. As soon as the main part has been secured to a component in a bonded manner with the bead thereof by friction welding, the functional part is indirectly but fixedly connected to the component. If desired, a rotationally fixed interlocking connection between the functional part and the main part can also be easily produced.

The two-part design makes it possible to combine different functional parts with structurally identical main parts, such that the functional part can be used, for example, to produce a snap connection or a screw connection by means of an internal thread or an external thread, without any change to the main part and the joining process according to the invention. For example, a securing element with a snap connection and a securing element with an internal thread can be secured to a component using the same device for friction welding without changing the process parameters, by the structurally identical main parts being combined with different functional parts and supplied to the device for friction welding. This is a significant advantage for process-reliable serial production of high-performance lightweight components.

The connection element according to the invention is very cost-effective since the materials of the two components (main part and functional part) can be optimized in accordance with the relevant task. The main part is, in many cases, made of a thermoplastic material. It is preferably made of a fiber-reinforced thermoplastic material such as PA 66 35 GF. Other (thermoplastic) plastics materials, with and without fiber reinforcement, can of course also be used. Polyphenylene sulfide (PPS), polyamide 6 (PA 6) and polypropylene with 30% glass fiber (PP GF30) are particularly suitable.

However, the connection element according to the invention can also be produced from a weldable metal material.

The connection element can then be connected to a metal component by friction welding. In this case, the component and the main part have to be weldable to one another. Since the functional part is only connected to the connecting part in an interlocking manner and not in a bonded manner, there are no restrictions with regard to the material of the functional part.

These non-exhaustive examples show the great flexibility and adaptability of the connection element according to the invention to a wide variety of requirement profiles.

According to the invention, at least one interlocking element is formed on the upper side and/or the outer contour of the main part, and the at least one interlocking element is designed to transmit the torque required during friction welding from a tool for joining to the main part.

The interlocking element or interlocking elements can, for example, comprise one or more preferably circular depressions (blind holes) in the upper side of the main part. It is also possible to form the interlocking elements as longitudinal grooves or depressions in the outer contour of the main part. Of course, it is also possible to form the main part with a non-rotationally symmetrical geometric outer contour, such as a polygon (triangle, square, pentagon, hexagon, . . . ) or as a Gleichdick, such that the torque required for friction welding can be introduced into the main part via the outer contour. This results in connection elements which have a smooth surface.

Due to the large number of possible interlocking elements, the design of the main part is hardly subject to any restrictions. Rather, design concerns can also be taken into account and an attractive design can be achieved.

For example, in applications where great importance is placed on cleanliness, an outer contour of the main part that has a smooth surface, without depressions or grooves, may be particularly advantageous. In this case, the outer contour of the main part can be a polygon or a Gleichdick. Blind holes and grooves on the outer contour can then be omitted.

In order to ensure a good and resilient transmission of tensile forces from the shank of the functional part to the main part, the head of the functional part is designed as a plate, preferably as a non-rotationally symmetrical plate. If the plate is not rotationally symmetrical and a corresponding depression is formed on the underside of the main part, torques can also be transmitted between the main part and the functional part. This is often advantageous when the functional part has an external or internal thread on the shank thereof and a screw or nut is to be screwed onto the functional part. The dimensions of the head are determined in accordance with the collective load (axial forces, torques) to which the connection element is exposed. expected axial forces are selected.

The functional part can optionally have a centering portion which interacts with the opening in the main part of the housing. The functional part is then centered in the opening of the main part by means of the centering portion. It is also possible to provide a tight fit or a slight interference fit in this case, such that when the centering portion of the functional part has been pressed into the opening of the main part, the two components of the connection element according to the invention are connected to one another. This facilitates the handling (manual or automated) of the connection element according to the invention before the main part is welded to the component.

Depending on the requirements of the application, the shank of the functional part can be part of a snap connection. However, it can also have an external thread or an internal thread. Transverse bores for receiving a cotter pin or a groove for receiving a securing ring (Seeger ring) are also formed. Barbs can also be arranged on the shank, by means of which soft materials are fixed to the shank. The shank can be designed in such a way that it can be optimally connected to one or more components. There are no limits on the design of the shank.

The claimed invention also includes a tool for joining the connection element to a component, the tool having an at least partially hollow or tubular tool body, the first end of which is designed in such a way that it forms a rotationally fixed interlocking connection with the main part and/or the centering portion of the functional part when said first end is placed on the connector. The cavity/central bore in the tool body is used to accommodate the shank of the functional part.

The first end of the tool according to the invention is complementary to the upper side or the outer contour of the main part. If, as shown for example in FIG. 1, depressions are formed in the upper side of the main part, then the first end of the tool according to the invention has three pins which enter the depressions when the tool is placed on the main part. A large number of other designs are possible. However, it is important that, due to the complementary design of the first end of the tool and the main part, the torque required for friction welding is transmitted from the tool to the main part during the friction welding process and the connection element according to the invention is thus connected to the component.

Further advantages and advantageous embodiments of the invention can be found in the following drawings, the description thereof and the claims. All of the features disclosed in the drawings, the description thereof and the claims can be essential to the invention both individually and in any combination with one another.

### DRAWINGS

In the drawings:

FIG. 1 is a view from above of a main part of a connection element according to the invention,

FIG. 2 is a side view of the main part,

FIG. 3 shows a section through the main part according to the invention,

FIG. 4 is a view from below of a main part according to the invention,

FIGS. 5 to 7 are different views of functional parts according to the invention,

FIG. 8 show the two-part connection element according to the invention with the main part and the functional part in a partial section;

FIG. 9 shows a two-part connection element welded to a component; and

FIG. 10 shows an embodiment of a tool according to the invention for joining the connection element to a component.

### DESCRIPTION OF THE EMBODIMENTS

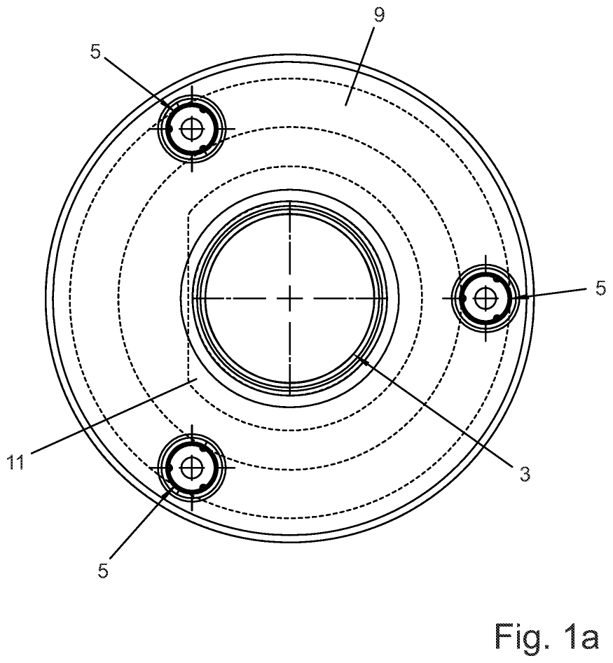

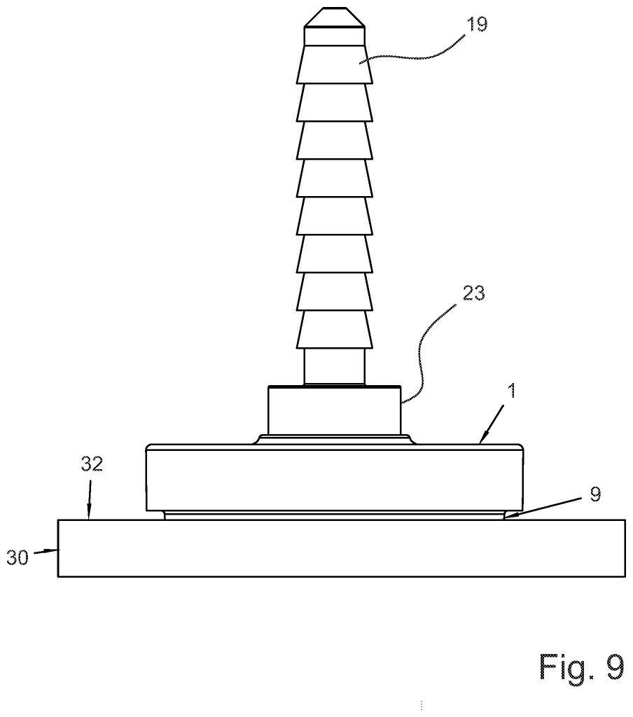

FIG. 1a is a view from above of the main part 1 of a connection element according to the invention. In this embodiment, the main part 1 is designed as a substantially circular disc or plate. Said main part has an opening 3 in the center. Three circular depressions 5 distributed over the circumference are arranged on the upper side of the main part 1. Said depressions are blind holes which are used to transmit the torque required for friction welding from the tool to the main part 1 with corresponding pins of a tool that are designed and arranged in a complementary manner (see FIG. 9).

Another alternative for torque transmission between a tool for friction welding and the main part 1 is shown in FIG. 1b: three longitudinal grooves or depressions 7 are arranged on the circular outer contour. The depressions 7 can form an interlocking engagement with corresponding ribs or pins on a tool for friction welding, and thus transmit the required torque from the tool to the main part 1. The depressions 5 according to the first embodiment can then be omitted.

It is not necessary to form both the depressions 5 and the grooves 7 on one base part. One of elements 5 or 7 is generally sufficient. The main part 1 can be centered relative to the tool by means of both the longitudinal grooves 7 and the depressions 5. However, it is also possible to center the main part 1 relative to the tool by means of the outer contour of the main part 1 and a complementary design of the tool, for example.

It is also possible to not form the main part 1 in a circular manner, but rather as a hexagon or as a Gleichdick (polygon), for example. The outer contour is then not rotationally symmetrical and it is possible to transmit the torque from the tool to the main part by means of a tool having a complementary shape. In this case, neither depressions 5 nor longitudinal grooves 7 are required. This results in a particularly smooth outer contour of the main part 1 that is less susceptible to contamination. This embodiment is not shown.

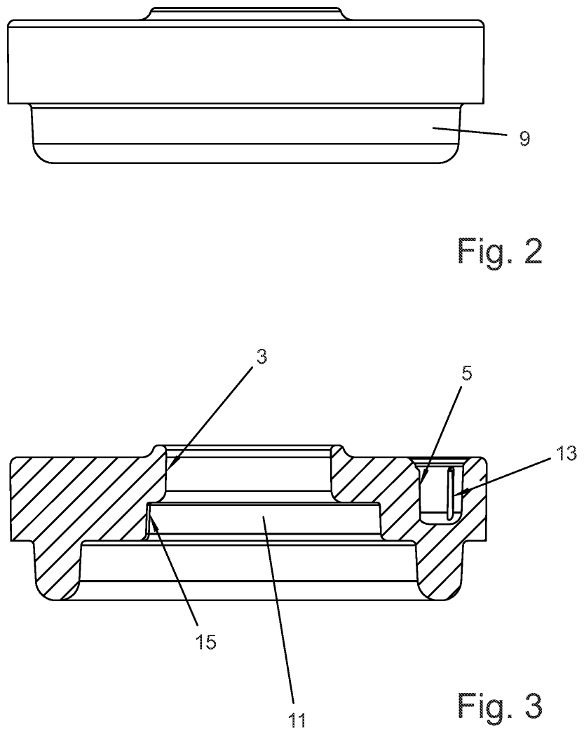

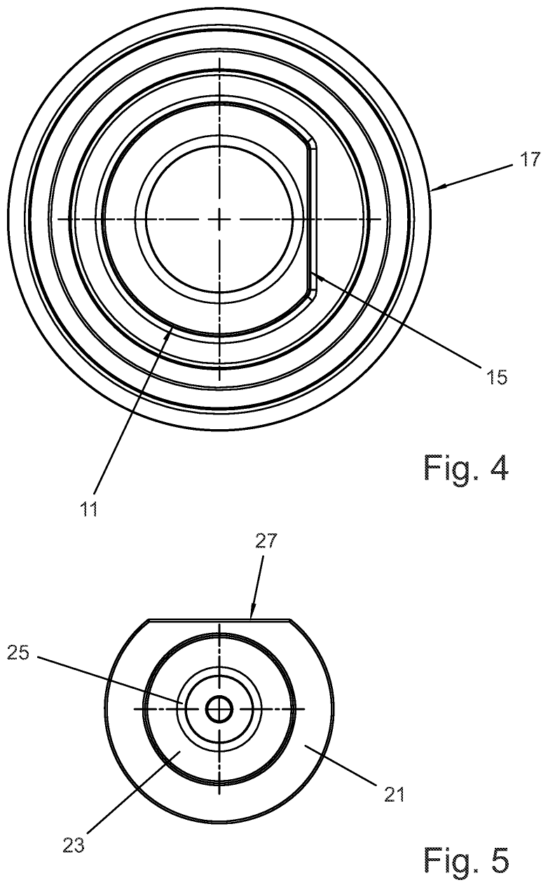

The dashed circular lines in FIGS. 1a and 1b show a bead 9 and a depression 11 on the underside of the main part 1. The form and function of the bead 9 and the recess 11 are explained in more detail below in connection with FIGS. 3 and 4.

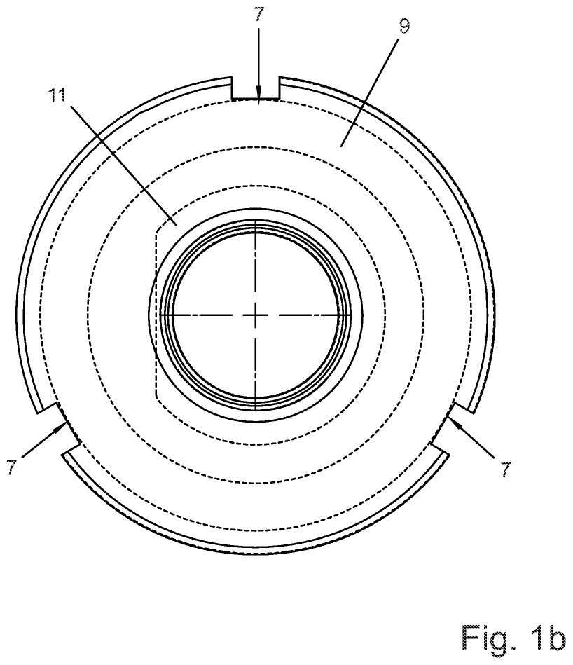

FIG. 2 is a side view of the main part 1 according to the invention. The disc-shaped basic structure of the main part 1 is clear from this side view. The bead 9 can be seen clearly on the underside of the main part 1 (at the bottom in FIG. 2). The bead 9 is used as a welding addition or material allowance for friction welding. Specifically, if the main part 1 is to be connected to a component (not shown) by friction welding, then the main part 1 is set in rotation and at the same time pressed with the bead 9 against the component. Due to the resulting frictional heat, the material of the bead 9 becomes at least partially soft and plastic. As soon as this process has progressed far enough, the rotation is stopped and the main part is pressed against the component with the liquefied/plasticized bead 9 thereof until the material of the bead 9 has solidified again.

In FIG. 3, the main part 1 is shown in section. In this view, the central opening 3 and one of the three depressions 5 can be seen clearly. A small rib 13 is formed in the depression 5. It is used to produce a press fit with a pin (not shown) of a tool for joining. The connection element (main part 1) according to the invention and the functional part (not shown) then no longer fall out of the tool before said element or part has been joined to the component.

The recess 11 on the underside of the main part 1 can be seen clearly in FIG. 3. The recess 11 has a circular basic shape, as can be seen particularly clearly from FIG. 4, and has a flattened portion 15 on the right-hand side; it is therefore not rotationally symmetrical. This flattened portion 15 is used to bring about a rotationally fixed interlocking connection with the head of a functional part (not shown).

The dimensions of the bead 9, in particular the height, width, diameter and cross section thereof, determine the available welding addition and the parameters of the friction welding process. The dimensions of the bead 9 can be adjusted according to the requirements of the application. The good adaptability of the connection element according to the invention to different applications is also evident here.

In the embodiment shown, the bead 9 is relatively large, such that a large amount of material is available for friction welding.

In FIG. 4, the main part 1 is shown in a view from below. The shape of the recess 11 with the flattened portion 15 can be seen particularly well from this view. The outer contour of the main part 1 is denoted by 17 in FIG. 4.

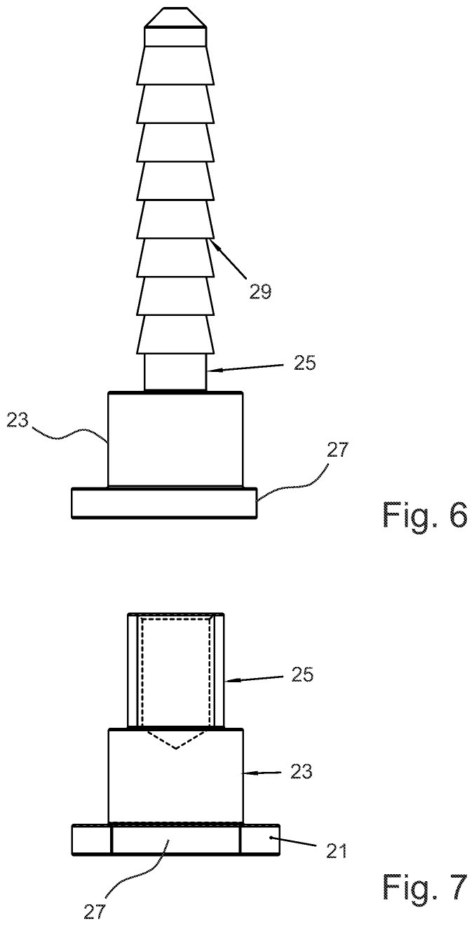

FIGS. 5 to 7 are different views of two embodiments of functional parts 19 according to the invention. FIG. 5 is a view from above of a first embodiment of a functional part 19. As can be seen from FIGS. 5 to 7, the functional part 19 comprises a head 21, a centering portion 23 and a shank 25 in all of the embodiments.

As can be seen particularly well from the view from above (FIG. 5), the head 21 is circular and has a flattened portion 27. The head 21 and the flattened portion 27 are complementary to the recess 11 with the flattened portion 15 on the underside of the main part 1, such that an interlocking rotationally fixed connection is produced between the head 21 of the functional part 19 and the main part 1 when the shank 25 is pushed from below through the opening 3 of the main part 1 until the head 21 abuts the main part 1.

In the embodiments shown, the functional part 19 comprises an (optional) centering portion 23, the dimensions of which are matched to the diameter of the opening 3 of the main part 1. When the shank 25 of the functional part is pushed through the opening into the main part, a slight press fit is preferably produced between the centering portion 23 and the opening 3 of the main part 1. This prevents the functional part 19 from accidentally falling out of the main part 1 again.

The flattened portions 15 and 27 in the recess 11 and the head 21, respectively, ensure a reliable and efficient transmission of torques between the functional part 19 and the main part 1. The torque transmission is not limited to the embodiments shown. Large axial forces can also be transmitted between the functional part 19 and the main part 1 via the head 21.

In FIG. 6, the shank 25 of the functional part 19 is designed as part of a snap connection. The shank comprises a plurality of undercuts 29 which, together with corresponding latching hooks or snap hooks of a counterpart (not shown), form the aforementioned snap connection.

An alternative functional part 19 is shown in FIG. 7 by way of example. In this case, the shank 25 has an internal thread. The centering portion 23 and the head 21 are structurally identical to the embodiment according to FIG. 6. This has the advantage that the functional parts 19 according to FIGS. 6 and 7 can alternatively be used in the same main part 1. As a result, nothing changes in the friction welding process for connecting the main part 1 to a component. Due to the two-part design, it is also possible to combine a large number of further functional parts 19 (not shown) with the same main part. There are hardly any limits on the freedom of design for the functional parts 19. It is also possible to produce the functional part 19 from a different material than the main part 1.

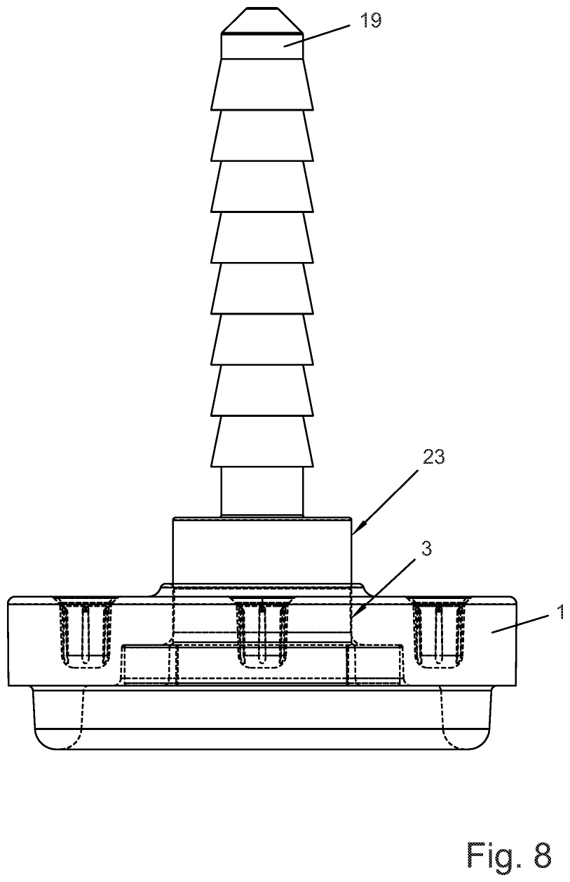

FIG. 8 shows an assembly drawing of the connection element according to the invention. The connection element 31 is formed in two parts. As already mentioned, the connection element comprises a main part 1 and a functional part 19. A slight press fit between the opening 3 and the centering portion 23 can ensure that the functional part 19 does not fall out of the main part 1.

The two-part connection element according to the invention can then be placed on a tool for joining and then connected to a component by friction welding in the manner described above.

FIG. 9 shows the connection element according to FIG. 8, which is connected to a composite material component 30 by friction welding. The bead 9 is significantly flatter and wider. This is a consequence of the plasticization and deformation of the bead 9 that occurs during friction welding. The joining area between the component 30 and the main part 1 of the connection element is much larger than the cross-sectional area of the bead 9 before friction welding. As a result, the load capacity of the connection is very high. As already mentioned, the joining surface can be adapted to the requirements of the individual case within very wide limits by the dimensions and design of the bead 9.

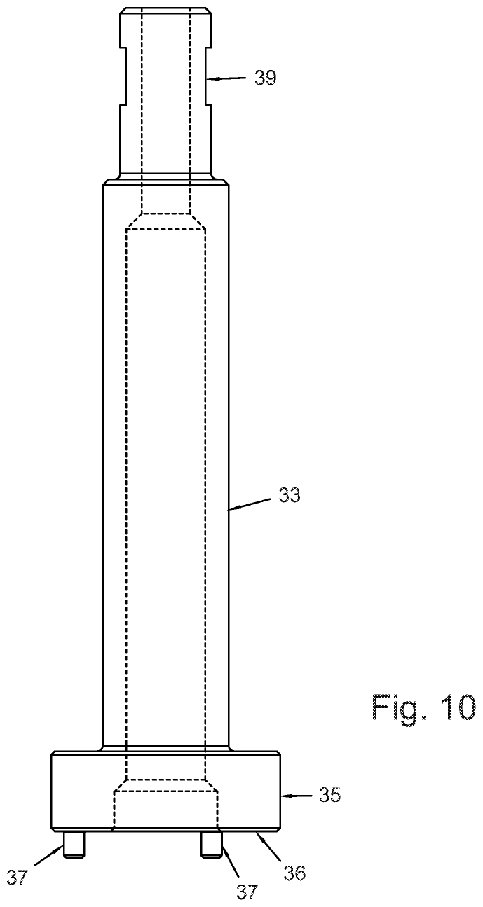

FIG. 10 shows an embodiment of a tool 31 according to the invention for joining. It comprises a tubular main body 33 which accommodates the shank 25 of the connection element.

A first end 35 of the tool 31 is designed as a contact surface 36 for the main part 1. Three pins 37 are pressed into the end face of the tool 31, two of which are visible. These pins 37 move into the depressions 5 of the main part 1 according to FIG. 1a and thus bring about an interlocking connection which is suitable for transmitting the torque required for friction welding from the tool to the connection element.

A drive element 39 is provided at an end opposite the first end 35. In the embodiment shown, the drive element 39 is a cylindrical pin having two parallel surfaces for clamping in the tool holder. The tool 31 is clamped in a device for friction welding with said drive element.

### LIST OF REFERENCE SIGNS

1 main part
3 opening
5 depression
7 longitudinal groove
9 bead
11 depression/recess
13 rib
15 flattened portion
17 outer contour
19 functional part
21 head
23 centering portion
25 shank
27 flattened portion
29 undercut
30 component
31 tool
33 tubular main body
35 first end
37 pin
39 drive element
41 internal thread

1. A connection element for securing to a surface of a component by friction welding, said connection element comprising:
a main part; and
a functional part, wherein
the main part has an upper side and an underside which is opposite the upper side and has an annular bead,
the main part has an opening connecting the upper side and the underside, and
the functional part has a shank and a head at a first end of the shank, and
the diameter or extension of which head transverse to a longitudinal axis of the shank is greater than a diameter of the opening.

2. The connection element according to claim 1, wherein
the main part has at least one interlocking element on the upper side and/or the outer contour, and
the at least one interlocking element is designed to transmit the torque required during friction welding from a tool for joining to the main part.

3. The connection element according to claim 2, wherein
the interlocking element comprises one or more depressions in the upper side of the main part.

4. The connection element according to claim 2, wherein
the interlocking element comprises one, two, three or more longitudinal grooves or depressions on the outer contour of the main part.

5. The connection element according to claim 2, wherein
the one interlocking element comprises a non-rotationally symmetrical outer contour.

6. The connection element according to claim 1, wherein
the head of the functional part is designed as a plate,

7. The connection element according to claim 1, wherein
the underside of the main part is complementary to the head of the functional part, such that the functional part and the main part are connected to one another in a rotationally fixed and interlocking manner.

8. The connection element according to claim 1, wherein
the functional part has a centering portion which interacts with the opening in the main part.

9. The connection element according to claim 8, wherein
the opening of the main part and the centering portion of the functional part are connected to one another in a rotationally fixed and interlocking manner.

10. The connection element according to claim 1, wherein
the shank of the functional part is designed as part of a snap connection with one or more undercuts.

11. The connection element according to claim 1, wherein
an external thread and/or an internal thread is formed on the shank of the functional part.

12. The connection element according to claim 1, wherein the main part made of a weldable material.

13. A tool for joining said connection element according to claim 1 to a component by friction welding, the tool comprising:
an at least partially hollow/tubular main body, wherein
a first end of the tool is designed in such a way that the first end of the tool forms a rotationally fixed interlocking connection with the main part and/or the centering portion of the functional part when said first end is placed on the connection element.

14. The tool according to claim 13, wherein
at least one pin is arranged on the first end of the main body in such a way that a rotationally fixed interlocking connection with the main part is produced when the tool is placed on the connecting part.

15. The tool according to claim 13, wherein
the first end of the main body is designed in such a way that a rotationally fixed interlocking connection with the main part and/or the centering portion of the functional part is produced when said first end is placed on the connecting part.

16. The connection element according to claim 1, wherein the connection element is a thermal adhesive bonding boss.

17. The connection element according to claim 2, wherein
the interlocking element comprises one or more circular depressions in the upper side of the main part.

18. The connection element according to claim 2, wherein
the one interlocking element comprises a non-rotationally symmetrical outer contour in the form of a regular or irregular polygon or a Gleichdick.

19. The connection element according to claim 1, wherein
the head of the functional part is designed as a plate, preferably as a non-rotationally symmetrical plate.

20. The connection element according to claim 1, wherein
the weldable material is a thermoplastic material or metal.
